(19) United States
(12) Patent Application Publication
(10) Pub. No.: US 2026/0208393 A1
(43) Pub. Date: Jul. 23, 2026

(54) CONCRETE SAW, CUTTING ENCLOSURE AND DUST COLLECTION SYSTEM WITH SKID PLATE AND METHOD

(71) Applicant: Kyle G. JENKINS, Columbia Station, OH (US)

(72) Inventor: Kyle G. JENKINS, Columbia Station, OH (US)

(21) Appl. No.: 19/451,432

(22) Filed: Jan. 16, 2026

Related U.S. Application Data
(60) Provisional application No. 63/746,627, filed on Jan. 17, 2025.

(51) Int. Cl. B28D 7/02; B28D 1/04

(52) U.S. Cl. CPC B28D 7/02; B28D 1/045

(57) ABSTRACT

Various concrete cutting devices using a cutting enclosure and dust collection system are described. The system generally includes a housing, a door releasably secured to the housing, a cutting blade within an interior of the housing, at least one baffle within the housing interior, a vacuum port, and a blade sight window in the door. Also described are vertically positionable and optionally biased skid plates associated with the housing and blade.

### CROSS-REFERENCE TO RELATED APPLICATIONS

This application claims priority from U.S. provisional application Ser. No. 63/746627 filed on Jan. 17, 2025, which is hereby incorporated by reference in its entirety. U.S. patent application Ser. No. 18/319,580, filed on May 18, 2023 and titled “CONCRETE SAW WITH CUTTING ENCLOSURE AND DUST COLLECTION SYSTEM”, and published as U.S. Publication No. US 2024/0227241A9 , published Jul. 11, 2024, is also hereby incorporated by reference in its entirely.

### FIELD

The present disclosure relates to concrete cutting tools, and particularly to concrete saws having dust collection systems with skid plates.

### BACKGROUND

Concrete cutting operations, particularly those involving green concrete, present significant challenges in dust control and surface protection. “Green cutting” or “early cutting” refers to cutting joints or forming cuts in concrete that has initially set but not fully cured or hardened. This technique has gained popularity as it can reduce random cracking and provide better-controlled joints in the concrete. However, cutting green concrete requires specialized equipment and techniques since the concrete surface is particularly susceptible to damage such as spalling, chipping, and raveling.

Traditional concrete cutting saws often employ water for dust suppression and blade cooling. However, water cannot be used when cutting green concrete as it would weaken the not-yet-fully-cured concrete surface. While various dust collection systems exist for dry cutting, they typically either inadequately contain dust or completely obscure the operator's view of the cutting area. Furthermore, existing systems generally lack effective means for protecting the vulnerable green concrete surface from damage during the cutting operation. A need exists for improved concrete cutting systems that can effectively control dust while allowing good visibility and protecting the concrete surface, particularly for green cutting applications.

### SUMMARY

The difficulties and drawbacks associated with previous approaches are addressed in the present subject matter as follows.

In one aspect, the present subject matter provides a concrete saw cutting enclosure and dust collection system including a dust enclosure housing defining an interior region, a rotary cutting blade at least partially disposed within the interior region of the housing, and a vacuum port providing airflow communication with the interior region of the enclosure. The system further includes a skid plate disposed along a lower region of the housing for reducing chipping or spalling of associated concrete being cut with the rotary cutting blade.

In another aspect, the present subject matter provides a concrete saw including a base unit including at least one wheel, a handle assembly secured to the base unit and a rotary power source. Additionally, the concrete saw includes a cutting enclosure and dust collection system, such as described in one of the embodiments disclosure herein, wherein the rotary blade is in operable engagement with the rotary power source.

In still another aspect, the present subject matter provides a method for cutting green concrete. The method comprises providing a concrete saw having a cutting enclosure and dust collection system, such as described herein. The method also includes positioning the concrete saw such that a blade of the saw is aligned with a line or joint to be cut in the green concrete. The method further includes actuating the saw so that the blade is rotating at a desired cutting speed. The rotating blade is contacted with the green concrete along the line or joint to be cut. The method also comprises moving the concrete saw along the line to be cut while the rotating blade contacts and cuts the green concrete.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a perspective view of a concrete saw cutting enclosure and dust collection system according to embodiments of the present disclosure.

FIG. 2 is an exploded perspective view showing various components of the system.

FIG. 3 is an underside view illustrating internal components including the blade mounting configuration and axial spacing between the blade and a consumable shoe.

### DETAILED DESCRIPTION OF THE EMBODIMENTS

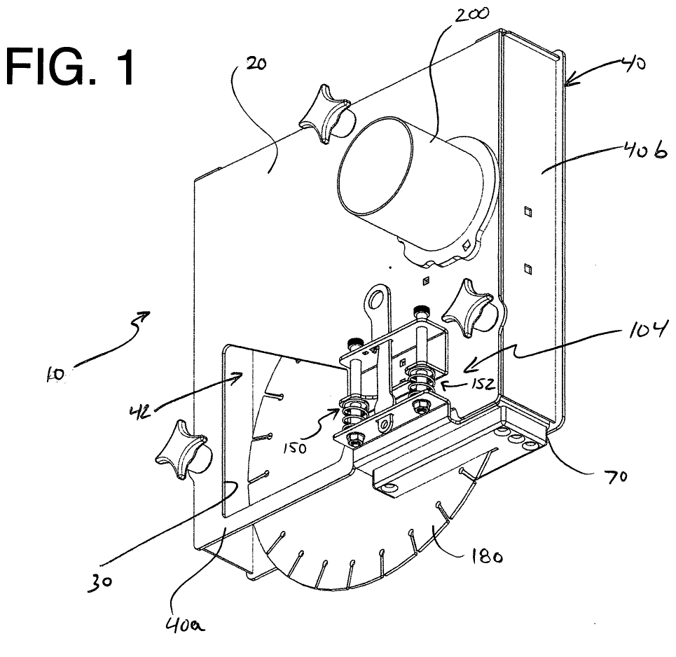

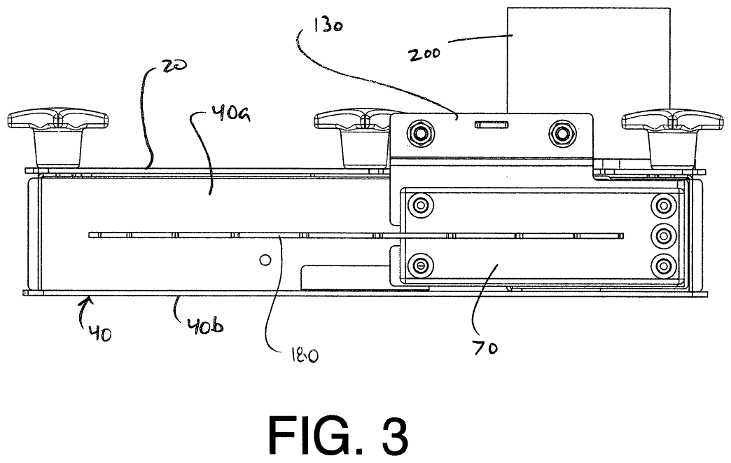

Referring to FIGS. 1-3, a concrete saw cutting enclosure and dust collection system 10 comprises a dust enclosure housing 40 that defines an interior region 42. A rotary cutting blade 180 is at least partially disposed within the interior region 42 of the housing 40. A vacuum port 200 provides airflow communication with the interior region 42 of the enclosure 40. The vacuum port 200 enables connection to an external vacuum source for dust collection during cutting operations.

As used herein, the term “skid plate” refers to a structural component positioned adjacent a lower region of the dust enclosure housing and configured to contact or engage an associated concrete surface during cutting. In some embodiments, the skid plate may include or support a separate wear component or “shoe,” which may be removably attached to the skid plate or to an intermediate base plate. The terms “shoe” and “consumable shoe,” when used herein, refer to such a wear component and do not require the skid plate itself to be formed from a consumable material. Unless expressly stated otherwise, references to a skid plate do not require the presence of a separate shoe.

A skid plate 104 is disposed along a lower region 40a of the housing 40 for reducing chipping or spalling of associated concrete being cut with the rotary cutting blade 180. The skid plate 104 is biased in a direction away from an underside of the dust enclosure housing 40 by biasing members 150, 152. More specifically, the skid plate 104 is spring biased in the direction away from the underside 40a of the dust enclosure housing 40 to apply downward pressure on the associated concrete being cut (concrete not shown). In the illustrated embodiment, the biasing members 150, 152 comprise springs that provide adjustable pressure control.

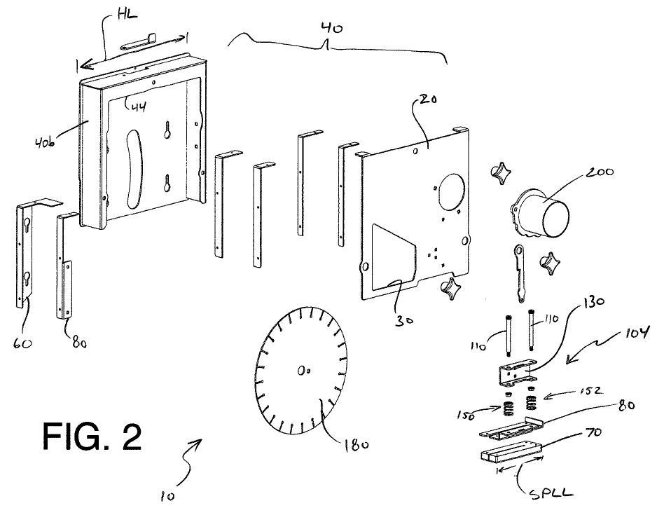

The skid plate 104 has a skid plate longitudinal length SPLL (see FIG. 2) and the housing 40 has a housing length HL (see FIG. 2). In one embodiment, the ski plate longitudinal length SPLL is less than the housing length HL of the dust enclosure housing 40. In some embodiments, the skid plate longitudinal length SPLL is less than one half the housing length HL. In the same or other embodiments, the skid plate longitudinal length SPLL is less than a diameter of the rotary cutting blade 180.

In the illustrated embodiment, the skid plate 104 includes a polymeric shoe 70 for reducing friction between the skid plate 104 and the associated concrete. The polymeric shoe 70 can be a plastic material such as ultra high molecular weight polyethylene (UHMW) selected for optimal wear characteristics and concrete surface protection. The shoe 70 can be a consumable shoe that is readily removable and replaceable. While UHMW plastic is used in one embodiment, other similar polymeric materials could also be suitable for the shoe in other embodiments.

Also, in other embodiments, the shoe 70 could be formed from any suitable material, including a metal material such as steel. Such metal materials may be particularly suitable in applications where concrete scratching is less critical and/or where longer shoe wear life is desired. Additionally, in some embodiments, the skid plate 104 may be used without a removable shoe, with the skid plate itself providing the concrete contact surface. The selection between a polymeric shoe, metal shoe, or no shoe configuration can be based on the specific application requirements including concrete age, desired surface finish, and anticipated usage duration.

As shown for the illustrated embodiment, a base plate 80 can be fixedly secured to the dust enclosure housing 40 and the consumable shoe 70 can be removably secured to the base plate 80. This configuration allows quick replacement of worn shoes while maintaining proper alignment. The consumable shoe 70 can be initially provided without a cutting slit. The rotary blade 180 cuts through the consumable shoe 70 to define the cutting slit upon first use of the rotary blade with the consumable shoe.

Advantageously, an axial spacing between each face of the rotary blade 180 and the shoe 70 is minimized, even so much so that that contact between the rotary blade and the shoe can occur during operation. This ensures optimal dust containment while maintaining shoe wear consistency. Also, this can reduce the likelihood of the associated concrete from chipping. Such minimized spacing can be facilitated by the choice of material for the shoe 70. For example, when the shoe 70 is plastic such as UHMW, there is minimal concern of the blade 180 contacting the shoe 70 as such contact will minimally impact the blade 180. While larger spacing may be preferred when using metal shoes, the system can accommodate various spacing configurations based on the shoe material selected.

The dust enclosure housing 40 of the illustrated embodiment includes a main housing body 40b defining an entryway 44 providing access to the interior region 42 of the dust enclosure housing. A door 20, which can be considered part of the dust enclosure housing 40, is releasably secured to the main housing body 40b and upon securement thereto generally covers the entryway 44. The skid plate 104 is secured to the door 20 in the illustrated embodiment. As described in the '580 application incorporated by reference hereinabove, the door 20 defines a blade sight window 30 enabling viewing of a portion of the blade 180 disposed within the interior region 42 of the housing 40, through the door 20.

Also the same or similar to that described in the '580 application, at least one baffle 60, 80 is positioned within the interior region 42 of the housing 40 and extends along at least one of an inner face and/or an outer face of the rotary blade 180. The baffles include a first baffle assembly 60 affixed to the housing 40 and extending along the inner face of the blade 180, and a second baffle assembly 80 affixed to the door 20 and extending along the outer face of the blade.

The first baffle assembly 60 can include an enclosure baffle seat affixed to the housing 40 and an enclosure baffle supported and retained on the enclosure baffle seat. Similarly, the second baffle assembly 80 can include a door baffle seat affixed to the door 20 and a door baffle supported and retained on the door baffle seat.

The skid plate 104 is vertically movable and selectively positionable relative to an axis of the rotary blade 180. The skid plate can include at least one vertical positioning assembly (two in the illustrated embodiment), each comprising the support member 130 secured to the housing 40, a stop secured to the skid plate 104, a force adjuster 110 disposed between the support member and the stop, and a biasing member 150 or 152 urging the stop and the skid plate away from the enclosure.

Referring to FIG. 10 from the '580 application, a complete concrete saw 300 comprises a base unit 310 including at least one wheel 330. A handle assembly 320 is secured to the base unit 310 and includes grips 322, 324 for operator control. A rotary power source 350 such as an electric motor provides power for the cutting operation. One of the cutting enclosure and dust collection systems 10 described herein can be mounted to the base unit 310 with the rotary blade 180 in operable engagement with the rotary power source 350. The power source 350 typically drives the blade 180 through a shaft connection 340 at speeds appropriate for concrete cutting.

A method for cutting green concrete using the concrete saw 300 can include the following. Initially, the operator positions the concrete saw 300 such that the blade 180 is aligned with a line to be cut in green concrete. The term “green concrete” refers to concrete that has set but has not fully hardened. By way of example and not limitation, green concrete may be cut within several hours after pouring, depending on environmental conditions and concrete composition. The operator then actuates the concrete saw 300 so that the blade 180 is rotating at a desired cutting speed. Cutting speeds are selected based on concrete conditions and cutting requirements and may vary depending on the saw configuration, blade type, and operating conditions. Example cutting speeds may range from about 1,000 to about 6,000 RPM depending on concrete conditions and cutting requirements, though other speeds could be employed. With the blade 180 rotating at proper speed, the operator contacts the rotating blade with the green concrete along the line to be cut. The skid plate 104 and particularly the polymeric shoe 70 help prevent surface damage during this initial contact and throughout the cutting operation.

The operator moves the concrete saw 300 along the line to be cut while the rotating blade 180 contacts and cuts the green concrete. During this cutting operation, the spring-biased skid plate 104 maintains consistent pressure against the concrete surface to prevent spalling or chipping. When using the polymeric shoe 70, the first cutting operation creates a cutting slit through the shoe as described above. This custom-cut slit ensures optimal alignment between the shoe and blade for maximum dust containment.

The method may include periodic replacement of worn shoes 70. The operator can quickly remove a worn shoe from the base plate 80 and install a new shoe. The new shoe is then cut during its first use to create a precisely aligned cutting slit. The frequency of shoe replacement may vary depending on the shoe material selected, with polymeric shoes typically requiring more frequent replacement than metal shoes.

During operation, the vacuum port 200 is typically connected to an external vacuum source that creates negative pressure within the housing interior region 42. This negative pressure effectively captures and removes concrete dust generated during cutting. The blade sight window 30 allows the operator to monitor blade alignment and cutting progress while maintaining dust containment. The window size of at least 10% of the blade's outer face area provides adequate visibility without compromising dust collection efficiency.

The vertical positioning assembly allows adjustment of the skid plate 104 height relative to the blade 180 to accommodate different cutting depths. The force adjuster 110 enables fine-tuning of the downward pressure applied by the biasing member 150 to optimize surface protection while maintaining stability.

The housing 40 includes mounting features for secure attachment to the base unit 310. These mounting features ensure proper alignment of the blade 180 with the power source 350 while maintaining the correct orientation of the dust collection system relative to the cutting surface.

The door 20 is secured to the housing 40 using fasteners that allow quick removal for blade changes and maintenance access. The door 20 is precisely aligned with the housing 40 to maintain proper dust containment during operation.

Various modifications and variations of the described embodiments are possible without departing from the scope of the disclosure. For example, alternative biasing mechanisms could be employed, different materials could be used for the shoe including various polymers or metals, the skid plate could be used with or without a removable shoe, or additional dust control features could be incorporated.

Many other benefits will no doubt become apparent from future application and development of this technology.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as described herein.

What is claimed is:

1. A concrete saw cutting enclosure and dust collection system, comprising:
a dust enclosure housing defining an interior region;
a rotary cutting blade at least partially disposed within the interior region of the housing;
a vacuum port providing airflow communication with the interior region of the enclosure; and
a skid plate disposed along a lower region of the housing for reducing chipping or spalling of associated concrete being cut with the rotary cutting blade.

2. The concrete saw cutting enclosure and dust collection system of claim 1, wherein the skid plate is biased in a direction away from an underside of the dust enclosure housing.

3. The concrete saw cutting enclosure and dust collection system of claim 2, wherein the skid plate is spring biased in the direction away from the underside of the dust enclosure housing to apply downward pressure on the associated concrete.

4. The concrete saw cutting enclosure and dust collection system of claim 1, wherein the skid plate has a skid plate longitudinal length and the dust enclosure housing has a housing length, and wherein the skid plate longitudinal length is less than the housing length.

5. The concrete saw cutting enclosure and dust collection system of claim 4 wherein the skid plate longitudinal length is less than one half the housing length.

6. The concrete saw cutting enclosure and dust collection system of claim 4, wherein the skid plate longitudinal length is less than a diameter of the rotary cutting blade.

7. The concrete saw cutting enclosure and dust collection system of claim 1, wherein the skid plate includes a polymeric shoe for reducing friction between the skid plate and the associated concrete.

8. The concrete saw cutting enclosure and dust collection system of claim 7, wherein the polymeric shoe is a plastic shoe.

9. The concrete saw cutting enclosure and dust collection system of claim 7, wherein the shoe is a consumable shoe readily removable and replaceable.

10. The concrete saw cutting enclosure and dust collection system of claim 9, wherein the skid plate includes a base plate fixedly secured to the dust enclosure housing and the consumable shoe is removably secured to the base plate.

11. The concrete saw cutting enclosure and dust collection system of claim 9, wherein the consumable shoe is initially provided without a cutting slit and the rotary blade cuts through the consumable shoe to define the cutting slit upon first use of the rotary blade with the consumable shoe.

12. The concrete saw cutting enclosure and dust collection system of claim 7, wherein an axial spacing between each face for the rotary blade and the shoe is minimized such that contact between the rotary blade and the shoe occurs.

13. The concrete saw cutting enclosure and dust collection system of claim 1, wherein the dust enclosure housing includes a main housing body defining an entryway providing access to the interior region of the dust enclosure housing and a door releasably secured to the main housing body and upon securement thereto generally covering the entryway.

14. The concrete saw cutting enclosure and dust collection system of claim 13 wherein the skid plate is secured to the door.

15. The concrete saw cutting enclosure and dust collection system of claim 13, wherein the door defines a blade sight window enabling viewing of a portion of the blade disposed within the interior region of the housing, through the door.

16. The concrete saw cutting enclosure and dust collection system of claim 1, further including at least one baffle positioned within the interior region of the housing and extending along at least one of an inner face and/or an outer face of the rotary blade.

17. The concrete saw cutting enclosure and dust collection system of claim 16 wherein the at least one baffle includes:
a first baffle assembly affixed to the housing and extending along the inner face of the blade; and
a second baffle assembly affixed to the door and extending along the outer face of the blade.

18. The concrete saw cutting enclosure and dust collection system of claim 17, wherein the first baffle assembly includes an enclosure baffle seat affixed to the housing and an enclosure baffle supported and retained on the enclosure baffle seat.

19. The concrete saw cutting enclosure and dust collection system of claim 17, wherein the dust enclosure housing includes a main housing body defining an entryway providing access to the interior region of the dust enclosure housing and a door releasably secured to the main housing body and upon securement thereto generally covering the entryway, and
wherein the second baffle assembly includes a door baffle seat affixed to the door and a door baffle supported and retained on the door baffle seat.

20. The concrete saw cutting enclosure and dust collection system of claims 1 wherein the skid plate is vertically movable and selectively positionable relative to an axis of the rotary blade.

21. The concrete saw cutting enclosure and dust collection system of claim 20 wherein the skid plate includes:
at least one vertical positioning assembly including a support member secured to the housing, a stop secured to the skid plate, a force adjuster disposed between the support member and the stop, and a biasing member urging the stop and the skid plate away from the enclosure.
